(19) United States
(12) Patent Application Publication
(10) Pub. No.: US 2005/0242238 A1
(43) Pub. Date: Nov. 3, 2005

(54) Parent plane

(76) Inventor: Christopher Francis Demanski, Cold Brook, NY (US)

Correspondence Address: Christopher F. Demanski, 228 Millwood Hill Road, Cold Brook, NY, 13324, US

(21) Appl. No.: 10/835,305

(22) Filed: Apr. 30, 2004

(51) Int. Cl. B64D 11/00

(52) U.S. Cl. 244/118.5

(57) ABSTRACT

In summary, the development of “The Parent Plane” will be an asset to all parties involved, the parents, the children, the passengers, and the airlines. The development of this idea will allow parents and children to travel by air no matter what the age of the child. Separating the plane into different areas will accommodate all ages. The parents and children will be more at ease with air travel knowing there are trained personnel on board and that they will not be aggravating other passengers. Other passengers will be more at ease knowing that they can actually have a “peaceful” flight with no children being on board, and the airline will greatly profit by offering this service to the public.

There are NO rights to invention made under federally sponsored research and development

### BACKGROUND OF INVENTION

One of the greatest traveling concerns of any individual is no longer their concern for safety from terrorists on the plane since 9-11, we have “Air-Marshals” to deal with that. It is not their concern and fear of the plane crashing into a mountain like in the movie “Alive”. The pilots and flight crews are way more trained than back then. It is the realization that at one point in time or the other, they may have to travel with their children.

I know this first hand, and anyone who has been on a plane with a screaming infant knows this first hand.

Just when you thought it would be safe to catch up on some sleep on the plane after a long business trip, or a rough weekend with the college buddies, in strolls “The Parent” with the backpack over one shoulder, and the ever so cute and adorable little monster in the arms. The monster is silenced for now, reconning it's new surroundings, and waiting . . . waiting for you to fall asleep. Just when all seems safe, the flight attendants have prepared for take off, and the plane begins to pick up speed traveling faster down the run way and your head begins to get heavier as well as your eye lids, you begin to get comfortable in your seat adjusting to your environment, and as the plane begins to take flight and your head sinks back into the seat cushion, and your eyes begin to close . . . WAAAAHHHHHH!!!!!!! The little monster comes to life with the first amount of pressure building up in their ears. The thing begins fanatically screaming and gasping for air as the WAH WAH WAAAAAHHHHHH fills the airplane and disturbs your slumber.

So much for catching up on the much needed sleep prior to your return to normal life.

However, you must look at the parents point of view. The parent, embarrassed due to the fact that everyone on the plane hears their kid, and concerned for their own child's well being and happiness, frantically tries to silence the child utilizing every trick they have seen or heard of in the past. They use the “Binky” trick, they use the “Air Phone” trick, they use the “Window Shade Closing” trick, they use the “Tray Table Closing trick, they use the “Read a Book” trick, they use the “Play with the Head Phones” trick, they use everything they can imagine just to try and keep their kid quiet in order not to annoy the other passengers, and stress themselves, or their child, out.

I can speak very fluently on this topic, and area. I am currently writing this on my lap top sitting in First Class in seat 3D United Flight UA1035 from Providence to Chicago Apr. 10, 2004. This is after traveling from Chicago earlier this afternoon with my 22 month old daughter Shelby who makes this trip once a month with me. We currently have over 25,000 miles this year and it's only April!!!.

I can speak from both sides of the fence, the “Parent” with the monster, and “The Parent” with out the monster. No matter how unbelievable of a father I am to my own daughter, the sound of another child crying on an airplane I am traveling on just makes me want to throw a shoe at the parent, and the monster for that matter, just to have some peace and quiet on my flight. You look at the parent like it's their fault that they have not trained or disciplined their child well enough to learn how to chew gum or swallow hard enough to deal with the pressure build up in it's ears. What kind of idiot does not teach their child to deal with cabin pressure?

Heaven forbid you are the un-expecting passenger who suddenly has to share a row with this monster. The lap child who will not sit still and crawls all over you and your seat like you are their godparent.

The passenger can only hope and pray that either they fall asleep, or the monster falls asleep (or has a heart attack and dies), so they can have some peace and quiet on their already stressful flight.

This is a problem and a concern which will be around FOREVER. As long as man continues to procreate and give birth, and as long as man continues to travel, we will have annoying little kids on planes, we will have stressed out parents trying to deal with their kids in order to not annoy other passengers, and we will have annoyed passengers who can not sleep from the screams of the 36 inch tall, 30 pound . . . MONSTER!!!!

Well, we know and understand the traveling concerns of today and tomorrow, so what is the solution???? Welcome to “The Parent Plane”, Chris Demanski, application Ser. No. 10/835,305.

1. This plane will be designed just for parents traveling with their children. All travelers with children would be put on this plane in order to not annoy other passengers, and help the parent of the traveling child be less stressed out. This will also ensure that any and all other travelers will not have to deal with the screaming little monsters on their flights. This will actually increase the amount of parents who travel by plane, opposed to travel by auto, by eliminating the FEAR of embarrassment, and safety. This will save money on food, with kids meals.
It is quite simple actually. I claim that all we would need to do is take a regular plane, and switch it around a little. I claim we can turn the First Class cabin into unaccompanied children area, which will pretty much be from ages 6 to 13 where they still may need some help in their travels. I claim that we can turn the main cabin into the “Parent with Children” area.
In the “Parents with Children” area, I claim there should be extra room in between the seats in order to allow the parents and children to move around. Almost like the amount of room that is currently in the First Class area. I claim we should put changing tables in the seats which would be assigned for the parents with infants probably in the back of the plane seeing how it will take more time to get on and off of the plane.
I claim we can have big screen projectors in all of the areas to show programs for the designated age group. Such as Baby Einstein in the infant area. Elmo and Finding Nemo in the 2-5 year old area, and PG type movies in the 6-13 year old area. I claim we can also have a day care attendant on the plane to aid the regular flight attendants, and I claim we can cross train the flight attendants to do both. I claim we could even hire on day care assistants, and train them to become flight attendants, which ever would be cheaper for the airline.
I claim these flights can be run from major cities on a monthly basis, a weekly basis, or a daily basis with the proper advertising. I claim there is a large demand for this type of exclusive travel, and the airline which capitalizes on it first will be able to reap the rewards of it for the rest of the time man kind is around.
I claim Exclusive parental air travel will be a major selling point to any air carrier. I therefore claim the invention of “The Parent Plane” to be my, Christopher F. Demanski, own idea, and therefore request the idea to be patented in my name through the United States Patent and Trademark Office.
This concludes the Claim for Chris Demanski, and his Patent application Ser. No. 10/835,305 for his invention of “The Parent Plane”.
